(19) United States
(12) Patent Application Publication
(10) Pub. No.: US 2025/0124220 A1
(43) Pub. Date: Apr. 17, 2025

(54) TABULAR DATA GENERATION

(71) Applicant: THE TORONTO-DOMINION BANK, TORONTO (CA)

(72) Inventors: Guangwei Yu, TORONTO (CA); Junwei Ma, TORONTO (CA); Anthony Lawrence Caterini, TORONTO (CA); George Frazer Stein, Port Coquitlam (CA)

(21) Appl. No.: 18/911,044

(22) Filed: Oct. 9, 2024

Related U.S. Application Data
(60) Provisional application No. 63/543,643, filed on Oct. 11, 2023.

(51) Int. Cl. G06F 40/177

(52) U.S. Cl. CPC G06F 40/177

(57) ABSTRACT

A tabular data model, which may be pre-trained on a different data set, is used to generate data samples for a target class with a given set of context data points. The tabular data model is trained to predict class membership of a given data point with a set of context data points. Rather than use the predicted class directly, the class predictions are used to determine a class-conditional energy for a synthetic data point with respect to the target class. The synthetic data point may then be updated based on the class-conditional energy with a stochastic update algorithm, such as stochastic gradient Langevin dynamics or Adaptive Moment Estimation with noise. The value of the synthetic data point is sampled as a data point for the target class. This permits effective data augmentation for tabular data for downstream models.

### CROSS-REFERENCE TO RELATED APPLICATION

This application claims the benefit of provisional U.S. application No. 63/543,643, filed Oct. 11, 2023, the contents of which is incorporated herein by reference in its entirety.

### BACKGROUND

This disclosure relates generally to generative computer models and more particularly to generating tabular data samples with pre-trained tabular data models.

Advances in deep generative modeling have not translated well to tabular data. Tabular data is pervasive and important across various domains, yet the application of deep generative modeling—successful in modalities like images and text—has lagged behind in the tabular setting. Previous approaches have not been effective at generative modeling for tabular data, particularly for smaller data sets or with low training costs. Conventional deep learning-based models demand substantial time and effort in terms of training and hyperparameter tuning, rendering them difficult to use across diverse data sets without dedicated training on each subject data set.

### SUMMARY

This disclosure provides a way to generate tabular data with a pre-trained tabular classification model using a class-conditional energy for a target class to be generated. Normally, the tabular classification model receives an input data point and a “context” describing a set of context data points describing the distribution in which the input data point is to be interpreted. The tabular classification model includes an attention mechanism for interpreting the input data point in view of the context and outputs class predictions for the input data point. To utilize this model for data generation, the class predictions are interpreted as an energy function output by the tabular classification model. Although such energy functions are typically interpreted without regard to classes (i.e., class-agnostic), a class-conditional energy function is determined, enabling analysis of the energy of an input data point with respect to a target class (and the input context).

The class-conditional energy may then be used to sample from the underlying distribution modeled by the function represented by the tabular classification model. This may be performed, for example, as a Markov chain in which a data point is updated based on the energy model (i.e., the class-conditional energy). A synthetic data point may be initialized and then updated to determine sampled points for a target class. The synthetic data point may be initialized, for example, based on values of the context data points of the target class. This initialization may be performed by sampling from a distribution determined based on the mean and variance of data values of the context points of the target class. The synthetic data point may then be evaluated by the tabular classification model, given the context and a target class, to determine a class-conditional energy for the synthetic data point. The synthetic data point is then updated with a stochastic gradient Langevin dynamics or Adaptive Moment Estimation with noise. The class-conditional energy and data point update may be repeated several times, during which the synthetic data point may be sampled as the generated data point for the target class. This approach enables a pre-trained tabular classification model to be effectively used for new data sets (i.e., using the data as a “context” forming part of the model input) for generating new data samples efficiently. Moreover, this approach in some embodiments may be used with a pre-trained tabular classification model without requiring additional training or hyperparameter tuning.

As such, this approach can augment data sets with generated data samples that can then be used to more effectively train downstream models (e.g., additional models) with the augmented data (e.g., to balance class frequency) and improve performance of the downstream models relative to training without the generated data samples.

### BRIEF DESCRIPTION OF THE DRAWINGS

FIG. 1 shows a tabular data generation system that includes a tabular data model, according to one embodiment.

FIG. 2 shows an example of a trained tabular data model, according to one embodiment.

FIG. 3 shows an example data flow for a class-conditional energy for tabular data generation, according to one embodiment.

FIG. 4 shows an example method for using a tabular data model for data generation, according to one embodiment.

FIG. 5 shows example data point plots including data points generated according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

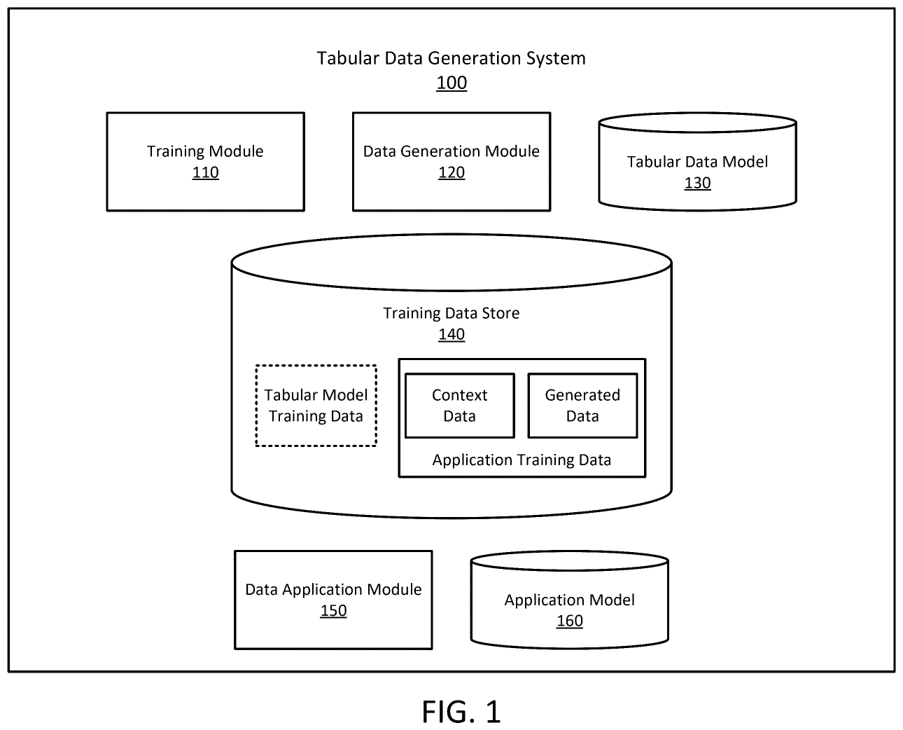

FIG. 1 shows a tabular data generation system 100 that includes a tabular data model 130, according to one embodiment. The tabular data generation system 100 includes various modules and data stores for using the tabular data model 130 to generate data points. The additional data may then also be used to train an application model 160 for application to new data points. In practice, additional or different modules and data stores may also be included in the tabular modeling system 100. In addition, the tabular data generation system 100 is shown here without connections to other systems; in practice, the tabular data generation system 100 may be connected to other systems and devices through a suitable network, such as the Internet, for receiving relevant data for a training data store 140 or data for inference (e.g., by application model 160).

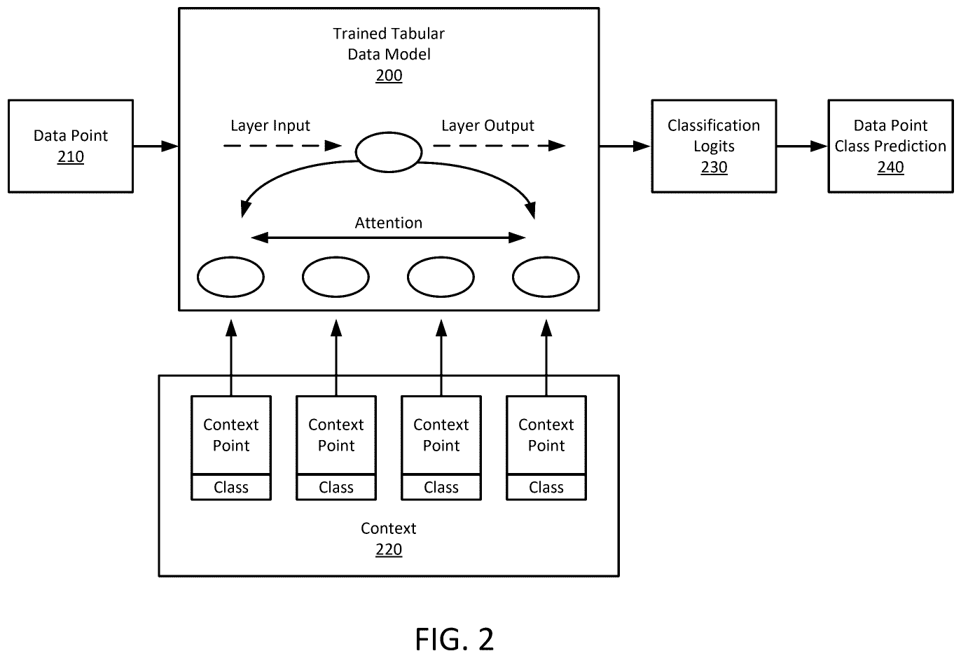

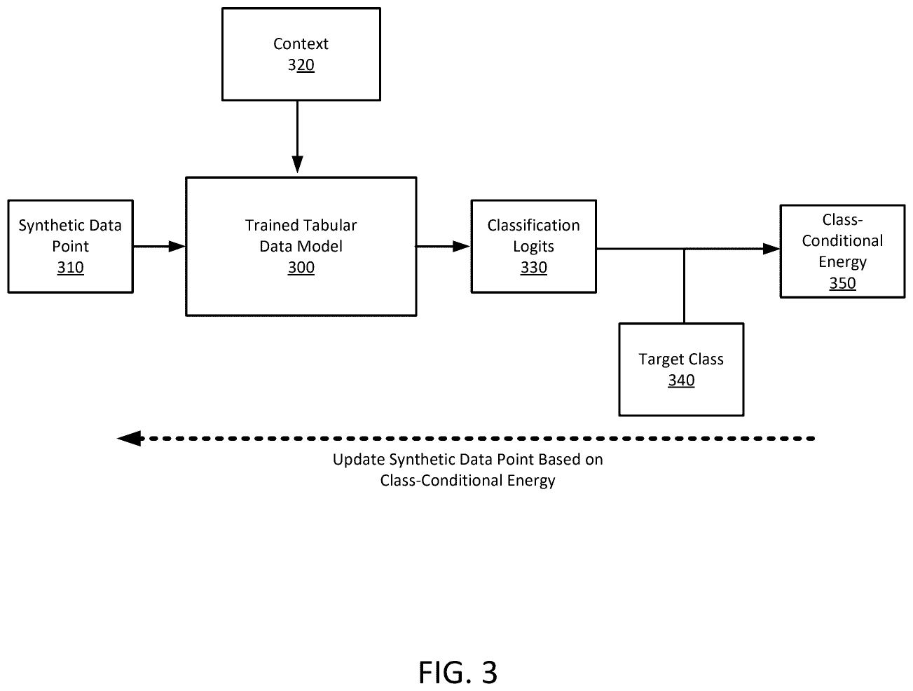

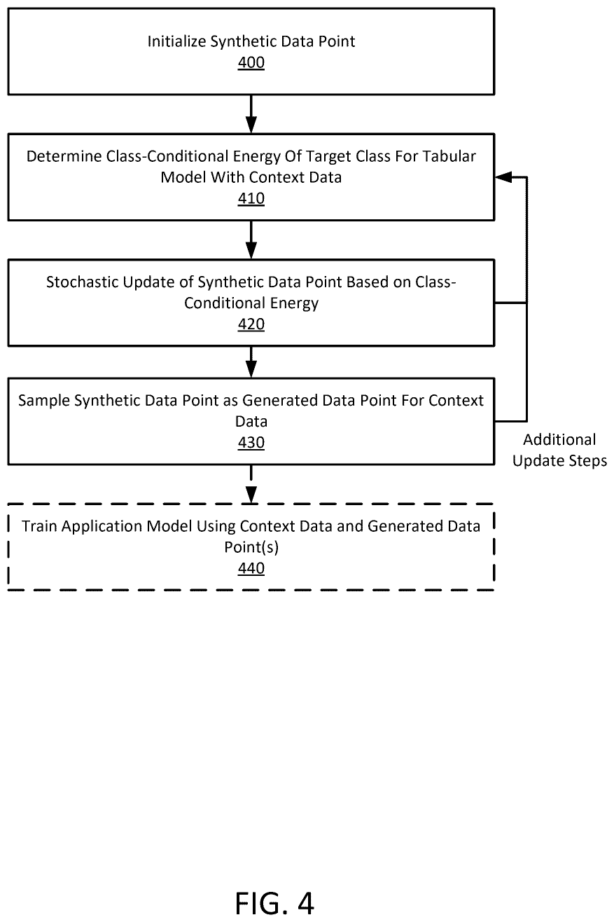

The tabular data model 130 is a trained computer model that learns parameters for interpreting tabular data and predicting data sample classification for an input data sample. As such, the tabular data model 130 may also be termed a tabular classification model. The tabular data model 130 receives an input data sample along with a “context” that includes a plurality of context data points as further discussed below and particularly in FIG. 2. A data generation module 120 may use the tabular data model 130 to determine a class-conditional energy for a target class based on a particular context to generate data point samples of the target class. The data generation module 120 is discussed move fully below with respect to FIGS. 3-4.

For a tabular data sample (which may also be referred to as a “data point”), the information of a particular data sample may include a plurality of features that may be independent from one another, and may represent, for example, patient data for a hospital or financial data for an individual. Each tabular data sample may thus include a plurality of features that may also be typically represented as a row in a spreadsheet or other tabular format defining values for a number of different fields. That is, the independence of different tabular data features/characteristics may differentiate this type of data from other types of data, such as image, sound, or video, where the data may be expected to contain higher degrees of correlation across portions of the input. For example, individual adjacent pixel data in an image is often similar in value, and the difference may be analyzed to determine something meaningful about the image (e.g., edge detection based on nearby pixel differences). These interrelationships and “position” across fields/features may often not exist in tabular data; for example, tabular data may include fields describing “age” and “sex” that are independent from one another. The tabular data model 130 may be used to predict a classification for a data point based on a context, such that the classification may describe, for example, membership in a particular group or a decision to be applied to a data point.

FIG. 2 shows an example of a trained tabular data model 200, according to one embodiment. A trained tabular data model 200 receives a data point 210 (e.g., features describing a data point) along with a context 220 and processes the data point 210 and the context 220 according to parameters of the trained tabular data model 200 to generate a data point class prediction 240. The trained tabular data model 200 may include a number of computer model processing layers (such as fully-connected layers, perceptrons, attention layers, activation layers, and so forth) with configurable parameters for processing the data point 210 and context 220 to yield the data point class prediction 240. As discussed below, the trained tabular data model 200 includes parameters trained with a variety of data set types as model training data. As such, the trained parameters of the model have been trained on various data sets with a variety of data set distributions and types of tabular data.

To apply the trained tabular data model 200 with a particular data set, the context 220 provides information about other points (i.e., the context points) within the particular data distribution in which the data point 210 appears. The trained tabular data model 200 may apply one or more attention layers to the context points and/or data point, and in some embodiments may be a transformer-style computer model. The attention mechanism of the trained tabular data model 200 may include a) attention from the evaluated data point 210 to the context points, and b) attention between the context points. Each context point in the context 220 may provide relevant features/information for the context point along with a class label of the context point. After the application of one or more layers of the trained tabular data model 200 to the data point, which may include attention mechanisms for the context 220, a number of classification heads may be applied to generate classification logits 230 that numerically describe activation for outputs associated with the various classes. To convert these to comparative likelihoods, a function, typically a SoftMax function, is applied to determine respective probabilities for each class, the highest of which is typically considered the data point class prediction 240.

In some embodiments, the trained tabular data model is a TabPFN (Tabular Prior-Data Fitted Network) architecture and may use the pre-trained parameters of the published TabPFN model. In some embodiments, the parameters of the trained tabular data model 200 are pre-trained from the perspective of the tabular data generation system 100. In circumstances in which the tabular data generation system 100 trains the tabular data model 200, the training data for the tabular data model typically does not include data points of the context 220 (or from the data set from which the context 220 is drawn). As the trained tabular data model 200 is trained on various types of data sets having different types of distributions and interrelationships within the data, the trained tabular data model 200 is expected to learn effective parameters to use the context 220 for inference with respect to the context data without additional fine-tuning or training of parameters of the trained tabular data model 200 on the context 220. As such, the trained tabular data model 200 may encode various types of prior distributions and related processing in the parameters of the trained tabular data model 200, such that the context 220 may be used to describe the particular distribution for evaluating the current data point 210.

Returning to FIG. 1, in typical operation, the tabular data model 130 processes a data point and a context to generate a data point classification. As further discussed herein, the data generation module 120 instead uses the tabular data model 130 to generate new tabular data points. In many cases, a further application model 160 may be trained with a set of application training data (shown in FIG. 1 as a portion of training data store 140). The data generation module 120 uses a set of data points (e.g., of the data set for training the application model 160) as context data to generate additional data points similar to the context data. This may be used, for example, to augment the training set for the application model 160. In other situations, the additional generated data points from the context data may be used for other purposes other than training a further computer model (e.g., the application model 160).

As such, the application model 160 may be “downstream” of the data generated with the tabular data model 130. For the relevant data set, the data generation module 120 may generate additional data samples by applying the tabular data model 130 to sample additional data points and create generated data. The original data set along with the generated data may then be used as the application training data for the application model 160.

The tabular modeling system 100 includes a training module 110 that may train parameters and other configuration settings of the tabular data model 130 and also the application model 160. The training data 140 may include training data related to various data samples, which may be referred to as “data points” or “instances,” to be used for determining parameters of each model. The training data store 140 may thus include two types of training data: tabular model training data used to train the tabular data model 130, and application training data used to train parameters of the application model 160. As such, the respective models may be trained with different data sets, and in particular, the tabular data model 130 may be trained with data sets that are different from the data set used as context data for generating additional data points that may be used as application training data. In many cases, the application model 160 may be fine-tuned for an application of the context data points and may be a relatively simpler computer model than the tabular data model 130. As such, where the tabular data model 130 may thus be trained on various data sets suitable for transfer learning (using the context) to a variety of other data sets, the application model 160 may be trained for a specific application of the context data.

In some embodiments, the tabular data model 130 is trained by another system and is received by the tabular data generation system 100 as pre-trained. The tabular model training data may include a number of different types of tabular data with different types of relationships between data points, features, and classifications. As such, the tabular model training data may include various distributions with different types of data set contexts to learn various types of distributions that may be presented with different types of contexts. The tabular data model 130 may be trained for various types of data distributions based on the variety of data distributions in the tabular model training data. The various types of data distributions may thus expose the model to a large number of possible inductive biases that may be observed in tabular data.

Similarly, the application model 160 may be trained for the particular application relevant to the context data. The application model 160 may be various types of models, including decision trees, neural networks, classification models, embedding models, and so forth, that may process data points to a relevant output according to its particular application. The model training module 110 may use any suitable machine-learning techniques to train parameters of the tabular data model 130 and the data application model 160. Such techniques may include supervised or unsupervised training techniques, evaluation of error/loss functions, backpropagation, gradient descent, and so forth, which may vary in different embodiments and for different applications.

In general, the addition of generated data to the training set used for training parameters of the application model 160 improves the performance of the application model 160 relative to training the application model 160 without the generated data. That is, even though the generated data samples may be obtained from the tabular data model 130 (which was not trained on the context data), the generated data samples are effective in improving performance of the trained application model 160. This approach may be particularly effective for relatively small data sets or data sets with class imbalances, enabling additional generated data to provide further examples to improve the application model 160.

A data application module 150 receives a new data point and applies the application model 160 to the new data point. The data application module 150 may thus receive tabular data samples from various sources (such as external devices) and apply the application model 160 to obtain an output relevant to the data sample. As the training data for the application model 160 may be augmented with additional generated data, the data application module 150 may more effectively apply the application model 160 with increased confidence as the performance of the application model 160 is improved with the additional data points in the generated data.

The tabular data generation system 100 is shown in relation to the components particularly related to the improved generation of tabular data points and their use as discussed herein. As such, the particular environment in which the tabular data generation system 100 operates may differ in various embodiments, as the tabular data generation system 100 may be operated on a server that receives requests from remote computing systems for application of requests to generate tabular data with the tabular data model 130. In other embodiments, the tabular data model 130 may be trained by one computing system and deployed to another computing system for application in generating data points for different contexts. In additional embodiments, the training of the tabular data model 130 and the application model 160 may also be separated to different computing systems. As such, the tabular data generation system 100 is any suitable computing system; components as disclosed below may be separated or combined appropriately across different computing systems for operation. Similarly, further components and features of systems that may include the tabular data generation system 100 itself and systems that may include components of the tabular modeling system 100 may vary and may include more or fewer components than those explicitly discussed herein.

### Class-Conditional Energy

FIG. 3 shows an example data flow for a class-conditional energy 350 for tabular data generation, according to one embodiment. In general, treating the output of a classification model directly as an energy score may be ineffective for generating samples for a specific target class because typical energy scores lack class information or a relationship to class predictions. FIG. 3 shows an example for determining a class-conditional energy, such that the class-conditional energy describes the energy related to the specific target class, such that improving the energy with respect to the class-conditional energy increases the consideration of the data point with respect to the target class. Of particular benefit, as the trained tabular data model 300 may be pre-trained with different data, this approach enables generating tabular data without any additional training or hyperparameter tuning of the trained tabular data model 300 for the specific data set being generated. Rather, providing the data set of interest as a context 320 and the pre-trained parameters of the trained tabular data model 300 (trained with respect to a variety of data distributions and potential context relationships) enables effective generation of data points using a class-conditional energy 350. In one embodiment, the generated data points may be generated as a Markov chain, such that the position of a synthetic data point 310 is used to determine the relevant class-conditional energy 350 of the synthetic data point 310. The class-conditional energy is then used to determine an update to the synthetic data point 310. After a number of updates, the synthetic data point 310 may then be used as the sampled data point.

The output of the trained tabular data model 300 typically provides an output as a set of classification logits 330 for a data point that is interpreted as a probability based on a SoftMax function as discussed in FIG. 2. The classification output for a particular output class of the trained tabular data model 300 may thus be considered a conditional distribution p(y|x) given by σ(f(x))[y], where x is the input data point having D-dimensions (here, the synthetic data point), y is the class label for x, f: [symbol] ^{D}→ [symbol] ^{K} represents the trained tabular data model 300 for K classes (with context 320), σ is the SoftMax function, and [y] denotes an indexing operation for target class y. That is, the typical application of the trained tabular data model 300 provides a conditional distribution of classes given the data point (and the context 320). As such, the classification logits 330 output by the trained tabular data model 300 may be described in this formulation as f(x).

Rather than a class given a data point, the class-conditional energy 350 aims to define an energy that can be interpreted for a particular data point given the target output class. During data point generation, a “synthetic” data point is evaluated and its values updated based on the associated energy of the synthetic data point with respect to the target class for that synthetic data point. Particularly, an Energy is determined as a function E(x_{synth}|y_{synth}) of the synthetic data point 310 x_{synth} as a function of a target class 340 y_{synth}. The class-conditional energy 350 defining an energy of the data point given the class (i.e., E(x_{synth}|y_{synth})) enables an update to be calculated for the data point based on the specific target class.

In some embodiments, to conceptually obtain the class-conditional energy 350 of the synthetic data point 310, the energy from the trained tabular data model 300 is interpreted to determine a class-agnostic energy and a class-specific modification. Initially, applying Bayes' rule, p(x|y)∝p(y|x)·p(x). Next, the probability of the data point p(x) without regard to class is proportional to a class-agnostic energy function E(x) that may be defined as:

$$E ( x ) = - Log Sum {Exp}_{{y}^{′}} ( f ( x ) [ {y}^{′} ] ) \qquad Equation 1$$

Then, the probability of the class given the data point p(y|x) may be written as p(y|x)=exp(f(x)[y]−LogSumExp_{y′}(f(x)[y′])). When combined with Eq. 1, this shows that the data point x given a class y has the following proportionalities: p(x|y)∝p(y|x)·p(x)∝exp(f(x)[y]). As such, the class-conditional energy E(x|y) may be given simply by

$$E ( x \vert y ) := - f ( x ) [ y ] \qquad Equation 2$$

where f(x)[y] is the classification logit 330 for the target class y. In one embodiment, the class-conditional energy is determined based on a logit or other activation function of the target class output by the trained tabular data model 300. That is, the class-conditional energy may be determined based on the output value of the target class before application of a SoftMax or other normalization function that may typically be applied to determine a most-likely class of the synthetic data point 310.

As such, this formulation enables class-conditional evaluation without specific evaluation of the class-agnostic energy or a cross-entropy evaluation across classes (e.g., to account for the SoftMax function across classes). By determining the class-conditional energy 350, the synthetic data point 310 can be iteratively updated with an update step using the evaluated class-conditional energy 350. As the class-conditional energy 350 is proportional to the probability noted above, the update step may effectively follow gradients of the class-conditional energy evaluated at the synthetic data point 310 to increase the likelihood of the data point belonging to the target class.

Thus, although the trained tabular data model 300 was initially designed for in-context classification tasks (i.e., discriminating whether a data sample belonged to a particular class given a context), this approach converts the trained tabular data model 300 output to a class-conditional energy 350 that can be used for generated data points of the target class 340.

### Data Generation

FIG. 4 shows an example method for using a tabular data model for data generation, according to one embodiment. To generate data samples using the class-conditional energy, energy-based sampling approaches are used, such as Markov chain sampling. As an overview, values for the data point (e.g., a synthetic data point) are evaluated with the class-conditional energy for the target class and then the data point is updated (e.g., modified) based on the class-conditional energy, for example based on gradients of the data point that will reduce the class-conditional energy.

Initially, the values of the features for the synthetic data point may be initialized 400 for exploration of the class-conditional energy. The synthetic data point may be termed “synthetic” because it represents a position in the input space that initially have no (or limited) relationship to the target class. Rather, as the synthetic data point is updated based on the class-conditional energy, the values of the synthetic data point may be expected to more-likely represent data of the target class. The synthetic data point may be initialized 400 in various ways in different embodiments. In one example, the synthetic data point is initialized to a value of one of the context data points of the target class. In another embodiment, the feature values of the synthetic data point are determined by sampling from a distribution based on data points of the target class (e.g., from the context data points of the target class). To do so, a mean and standard deviation of the feature values may be determined for the data points of the target class to define a respective probability distribution, and the synthetic data point may be initialized 400 by sampling from the respective distribution for each feature.

Next, the class-conditional energy of the target class is determined 410 by applying the synthetic data point with the context data to the tabular model. The class-conditional energy may be determined as discussed above, e.g., with respect to FIG. 3. As such, in one embodiment, the class-conditional energy may be defined as:

$$E ( {x}_{synth} ) = - log f ( {x}_{synth} \vert ( {x}_{con} , {y}_{con} ) ) [ {y}_{synth} ] \qquad Equation 3$$

where x_{synth} is the synthetic data sample,
f( ) is the tabular data model,
y_{synth} is the target class, and
x_{con}, y_{con} is the context data and associated class labels.

In additional embodiments, the class-conditional energy includes a term based on the energy of the set of context data points. In this embodiment, the term based on the context data points may swap the position of the context data points with the synthetic data point in evaluating the class-conditional energy:

$$E ( {x}_{synth} \vert {y}_{synth} ) + E ( {x}_{con} \vert {y}_{con} ) = - log f ( {x}_{synth} \vert ( {x}_{con} , {y}_{con} ) ) [ {y}_{synth} ] - log f ( {x}_{con} \vert ( {x}_{synth} , {y}_{synth} ) ) [ {y}_{con} ] \qquad Equation 4$$

In the embodiment using Equation 4, the additional term using the energy of the context data points may operate to regularize the updates of the synthetic data points.

After determining 410 the class-conditional energy the synthetic data point is stochastically updated 420 based on the class-conditional energy. As the class-conditional energy may be based on the position (i.e., the various feature values) of the synthetic data point 400, the position of the synthetic data point may be stochastically updated (i.e., with a randomization element) to explore the energy space based on the local class-conditional energy at the synthetic data point. In one embodiment, the synthetic data point is updated with an algorithm using stochastic gradient Langevin dynamics (SGLD). As such, the update of the synthetic data point from one iteration (t) to the next (t+1) may be defined in one embodiment as:

$${x}_{synth}^{t + 1} = {x}_{synth}^{t} - α \cdot \frac{\partial E ( {x}_{synth}^{t} \vert {y}_{synth} )}{\partial {x}_{synth}^{t}} + σ \cdot N ( 0 , I ) \qquad Equation 5$$

As such, the differential energy relative to change in the synthetic data point, in addition to noise, is used to update the position of the synthetic data point. Because this approach can also be considered a stochastic gradient descent with noise, in another embodiment the synthetic data point is stochastically updated 420 with an adaptive moment estimation (ADAM) optimizer with added noise.

The class-conditional energy and stochastic update thus allow exploration of the underlying class-conditional energy determined by the trained tabular data model and related context data points without requiring additional retraining of the tabular data model. The calculation of class-conditional energy and stochastic update may be performed for a number of iterative steps before sampling 430 the position of the synthetic data point as a generated data point of the target class. That is, “sampling” of the energy model may include exploration with the class-conditional energy to update position of the synthetic data point and using the position of the synthetic data point as the sampled data point from the energy model. In some embodiments, the synthetic data point may be updated a minimum number of iterations (e.g., 10, 50, 100) before sampling 430 the data point. In addition, after sampling 430, in some embodiments the synthetic data point may continue to be updated for sampling further points. For example, the synthetic data point may be sampled 430 after each 5 or 10 steps/iterations of updating 420 the synthetic data point.

Finally, as discussed above, the generated data points (i.e., those sampled 430) may be used with the context data points to train 440 an application model with training data thus augmented by the generated data points. Because the generated data points incorporate the predictions from the various types of data sets used to train the tabular data model, the generated data more effectively mimics the context data set and yields application models that perform better in future applications than augmentation of tabular data by other generative means.

Using this approach, a generative model based on the pre-trained flexible classification model for tabular data is used to generate and synthesize new data points that maintains a link to the broad types of classification tasks solved by the trained classification models.

### Experiments

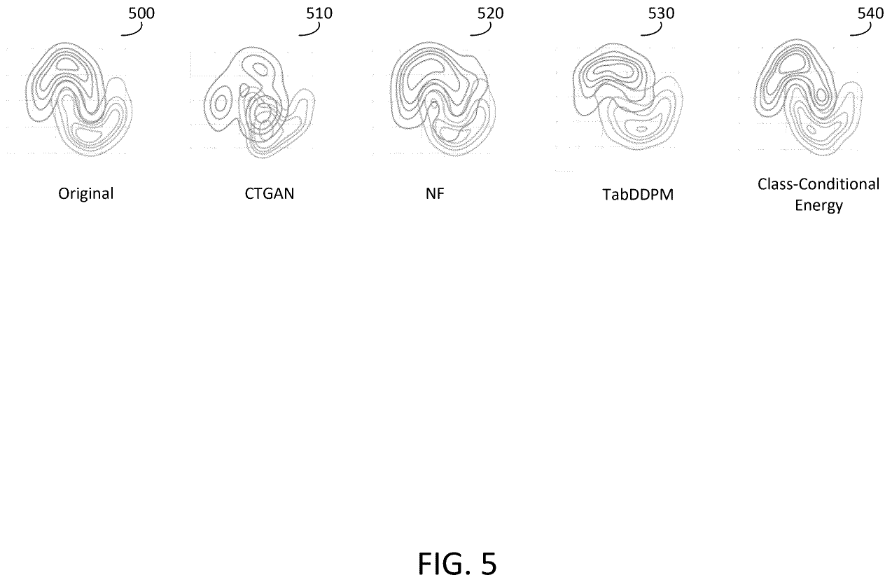

FIG. 5 shows example data point plots including data points generated according to one embodiment. FIG. 5 shows contour and the marginal plots for generative models on the popular two-moons dataset. An original data set 500 shows the distribution of data points in the context data set used for generation (i.e., the two-moons data set). Various generative approaches were applied to determine the similarity of generated data to the original context data points. A model using class-conditional energy provided the most-similar results shown as data set 540. Other methods include generative adversarial networks, namely Conditional Generative Adversarial Network (CTGAN), shown in data set 510; naturalizing flows (NF) shown in data set 520; and diffusion-based networks, namely “TabDDPM”, shown in data set 530. As can be shown visually, the generated data using class-conditional energy of data set 540 most similarly matches the original data set 500.

In additional experiments, embodiments of the present invention improved performance of various types of downstream models relative to other approaches for tabular data generation, indicating improved application model performance using the class-conditional energy discussed above.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for generating synthetic data points, comprising:
a processor configured to execute instructions;
a computer-readable medium having instructions executable by the processor for:
identifying a synthetic data point of tabular data;
updating the synthetic data point with respect to a set of context data points by:
determining a class-conditional energy of a target class for the synthetic data point applied to a pre-trained tabular classification model with respect to the set of context data points;
stochastically updating the synthetic data point based on the class-conditional energy of the target class; and
sampling the synthetic data point as a generated data point for the target class.

2. The system of claim 1, wherein the pre-trained tabular classification model is not trained on the set of context data points.

3. The system of claim 1, wherein identifying the synthetic data point comprises sampling from a distribution based a subset of the context data points having the target class.

4. The system of claim 1, wherein the set of context data points include a first subset of context data points associated with the target class and a second subset of context data points associated with at least one other class differing from the target class.

5. The system of claim 1, wherein the instructions are further executable for:
training an application computer model with training data that includes the generated data point and one or more data points from the set of context data points.

6. The system of claim 1, wherein the class-conditional energy includes a term based on the energy of the set of context data points given the respective class of the context data points.

7. The system of claim 1, wherein stochastically updating the synthetic data point based on the class-conditional energy of the target class comprises applying stochastic gradient Langevin dynamics.

8. The system of claim 1, wherein stochastically updating the synthetic data point based on the class-conditional energy of the target class comprises applying Adaptive Moment Estimation (Adam) with noise.

9. A method for generating synthetic, the method comprising:
identifying a synthetic data point of tabular data;
updating the synthetic data point with respect to a set of context data points by:
determining a class-conditional energy of a target class for the synthetic data point applied to a pre-trained tabular classification model with respect to the set of context data points;
stochastically updating the synthetic data point based on the class-conditional energy of the target class; and
sampling the synthetic data point as a generated data point for the target class.

10. The method of claim 9, wherein the pre-trained tabular classification model is not trained on the set of context data points.

11. The method of claim 9, wherein identifying the synthetic data point comprises sampling from a distribution based a subset of the context data points having the target class.

12. The method of claim 9, wherein the set of context data points include a first subset of context data points associated with the target class and a second subset of context data points associated with at least one other class differing from the target class.

13. The method of claim 9, wherein the method further comprises:
training an application computer model with training data that includes the generated data point and one or more data points from the set of context data points.

14. The method of claim 9, wherein the class-conditional energy includes a term based on the energy of the set of context data points given the respective class of the context data points.

15. The method of claim 9, wherein stochastically updating the synthetic data point based on the class-conditional energy of the target class comprises applying stochastic gradient Langevin dynamics.

16. The method of claim 9, wherein stochastically updating the synthetic data point based on the class-conditional energy of the target class comprises applying Adaptive Moment Estimation (Adam) with noise.

17. A non-transitory computer-readable medium, the non-transitory computer-readable medium comprising instructions executable by a processor for:
identifying a synthetic data point of tabular data;
updating the synthetic data point with respect to a set of context data points by:
determining a class-conditional energy of a target class for the synthetic data point applied to a pre-trained tabular classification model with respect to the set of context data points;
stochastically updating the synthetic data point based on the class-conditional energy of the target class; and
sampling the synthetic data point as a generated data point for the target class.

18. The computer-readable medium of claim 17, wherein the instructions are further executable for:
training an application computer model with training data that includes the generated data point and one or more data points from the set of context data points.

19. The computer-readable medium of claim 17, wherein stochastically updating the synthetic data point based on the class-conditional energy of the target class comprises applying stochastic gradient Langevin dynamics.

20. The computer-readable medium of claim 17, wherein stochastically updating the synthetic data point based on the class-conditional energy of the target class comprises applying Adaptive Moment Estimation (Adam) with noise.
